(19) United States
(12) Patent Application Publication
(10) Pub. No.: US 2020/0153036 A1
(43) Pub. Date: May 14, 2020

(54) SULFIDE-BASED SOLID ELECTROLYTE SYNTHESIZED USING WET PROCESS AND COMPOSITION AND METHOD FOR MANUFACTURING THE SAME

(71) Applicants: Hyundai Motor Company, Seoul (KR); KIA Motors Corporation, Seoul (KR); Industry-University Cooperation Foundation Hanyang University, Seoul (KR)

(72) Inventors: Ju Yeong Seong, Gyeonggi-do (KR); In Woo Song, Gyeonggi-do (KR); Hong Seok Min, Gyeonggi-do (KR); Yong Jun Jang, Gyeonggi-do (KR); Yun Sung Kim, Seoul (KR); Young Jin Nam, Gyeonggi-do (KR); Sung Hoo Jung, Gyeongsangnam-do (KR); Dae Yang Oh, Gyeonggi-do (KR); Yoon Seok Jung, Seoul (KR)

(73) Assignees: Hyundai Motor Company, Seoul (KR); KIA Motors Corporation, Seoul (KR); Industry-University Cooperation Foundation Hanyang University, Seoul (KR)

(21) Appl. No.: 16/426,528

(22) Filed: May 30, 2019

(30) Foreign Application Priority Data
Nov. 8, 2018 (KR) 10-2018-0136268

(51) Int. Cl. H01M 10/0562; H01M 10/052

(52) U.S. Cl. CPC H01M 10/0562; H01M 2300/0068; H01M 2220/20; H01M 10/052

(57) ABSTRACT

Disclosed are a five-component (Li-M-P—S—X) sulfide-based solid electrolyte synthesized using a wet process and a composition for manufacturing the same. The sulfide-based solid electrolyte is expressed as chemical formula 1 of A(Li₂S).B(P₂S₅).C(MX₄). A, B and C are respectively moles of Li₂S, P₂S₅ and MX₄, and satisfy 60<A<100, 0<B<40, 0<C≤30 and A+B+C=100, M may include at least one selected from the group consisting of Ge, Si, Sb, Sn and combinations thereof, and X may include at least one selected from the group consisting of Cl, Br, I and combinations thereof.

### CROSS-REFERENCE TO RELATED APPLICATION

This application claims priority to and the benefit of Korean Patent Application No. 10-2018-0136268, filed on Nov. 8, 2018, the entire contents of which is incorporated herein by reference.

### FIELD

The present disclosure relates to a five-component (Li-M-P—S—X) sulfide-based solid electrolyte synthesized using a wet process and a composition for manufacturing the same.

### BACKGROUND

The statements in this section merely provide background information related to the present disclosure and may not constitute prior art.

Secondary batteries which are rechargeable are used not only in small electronic devices, such as mobile phones, notebook computers, etc., but also in large transportation, such as hybrid vehicles, electric vehicles, etc. Accordingly, development of a secondary battery having higher stability and energy density has been desirable.

Most conventional secondary batteries constitute cells based on an organic solvent (an organic liquid electrolyte) and thus have limits in improvement in stability and energy density thereof.

On the other hand, all solid state batteries using an inorganic solid electrolyte are based on technology in which an organic solvent is excluded and cells thereof may be manufactured in a safer and simpler format and, thus, all solid state batteries are being spotlighted now.

Solid electrolytes are divided into oxide-based solid electrolytes and sulfide-based solid electrolytes. Sulfide-based solid electrolytes have higher lithium ionic conductivity than oxide-based solid electrolytes. Further, the sulfide-based solid electrolytes have excellent ductility and thus have high process flexibility, thereby being used for various purposes.

Non-patent document 1 discloses Li₃PS₄, which is a three-component, i.e., Li—P—S, sulfide-based solid electrolyte, synthesized using a wet process, and non-patent document 2 discloses Li₇P₂S₈I, which is a four-component, i.e., Li—P—S—X (X being a halogen element), sulfide-based solid electrolyte, synthesized using a wet process.

If a sulfide-based solid electrolyte is synthesized using the wet process, as described above, a large-scale solid electrolyte may be manufactured and is thus advantageous in manufacture of all solid state batteries having a large capacity, and the sulfide-based solid electrolyte may be mass-produced and is thus suitable for mass-production of all solid state batteries.

The above information disclosed in this Background section is only for enhancement of understanding of the background of the disclosure and therefore it may contain information that does not form the prior art that is already known in this country to a person of ordinary skill in the art.

### SUMMARY

The present disclosure provides, in one aspect, a method to synthesize a sulfide-based solid electrolyte having a new composition using raw materials which are not conventionally reported.

The present disclosure provides, in one aspect, a method to synthesize a sulfide-based solid electrolyte using a wet process.

The present disclosure provides, in one aspect, a novel sulfide-based solid electrolyte having higher ionic conductivity than conventional sulfide-based solid electrolytes.

In one aspect, the present disclosure provides a sulfide-based solid electrolyte expressed as chemical formula 1,

A(Li₂S).B(P₂S₅).C(MX₄) [Chemical Formula 1]

Wherein A, B and C are respectively moles of Li₂S, P₂S₅ and MX₄, and satisfy 60<A<100, 0<B<40, 0<C≤30 and A+B+C=100, M comprises at least one selected from the group consisting of Ge, Si, Sb, Sn and combinations thereof, and X comprises at least one selected from the group consisting of Cl, Br, I and combinations thereof.

In one aspect, the sulfide-based solid electrolyte may satisfy a composition expressed as chemical formula 2,

(1−x)[y(Li₂S).(100−y)(P₂S₅)].x[(100−z)(Li₂S).z(MX₄)] [Chemical Formula 2]

Here, 0<x≤0.85, 70≤y≤90 and 0<z≤35.

In another aspect, the sulfide-based solid electrolyte may satisfy a composition expressed as chemical formula 3,

(1−x)(75Li₂S.25P₂S₅).x(67Li₂S.33MX₄) [Chemical Formula 3]

Here, 0<x≤0.85.

In another aspect, the sulfide-based solid electrolyte may represent peaks in ranges of 2θ=17.5°±0.5°, 18.1°±0.5°, 20.0°±0.5°, 20.9°±0.5°, 25.0°±0.5°, 27.8° 0.5°, 29.2°±0.5°, 30.0°±0.5°, 31.4°±0.5° and 33.3°±0.5° when an X-ray diffusion (XRD) pattern is measured.

In another aspect, the sulfide-based solid electrolyte may have negative ion cluster distributions of PS₄³⁻ and (MS_{1/2}S₃)³⁻ and have M-S bonding.

In another aspect, the present disclosure provides a composition for manufacturing the sulfide-based solid electrolyte, including raw material including Li₂S, P₂S₅ and MX₄, and a solvent configured to dissolve or disperse the MX₄.

In one aspect, the raw materials may include greater than 60 mol % to less than 100 mol % of Li₂S, greater than 0 mol % to less than 40 mol % of P₂S₅, and greater than 0 mol % to 30 mol % or less of the MX₄.

In one aspect, the solvent may comprise at least one selected from the group consisting of tetrahydrofuran (THF), acrylonitrile (AN) and a combination thereof.

In still another aspect, the present disclosure provides a method for manufacturing the sulfide-based solid electrolyte, including preparing a mixture of raw materials, and inputting the mixture into a solvent and agitating the mixture in the solvent.

In aspect, the method may further include heat-treating an agitated product.

In another aspect, the raw materials may include greater than 60 mol % to less than 100 mol % of Li₂S, greater than 0 mol % to less than 40 mol % of P₂S₅, and greater than 0 mol % to 30 mol % or less of the MX₄.

In another aspect, the solvent may comprise at least one selected from the group consisting of tetrahydrofuran (THF), acrylonitrile (AN) and a combination thereof.

In another aspect, the method may further include removing the solvent, prior to the heat-treating the agitated product.

In one aspect, the heat-treating may be performed in a vacuum condition, inert gas condition or hydrogen sulfide atmosphere at a temperature of 140 to 800° C. for 30 minutes to 12 hours.

In a further aspect, the present disclosure provides an all solid state battery including a positive electrode, a negative electrode, and a solid electrolyte layer disposed between the positive electrode and the negative electrode, wherein at least one of the positive electrode, the negative electrode and the solid electrolyte layer includes the sulfide-based solid electrolyte.

Other aspects of the disclosure are discussed infra.

The above and other features are discussed infra.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

The above and other features of the present disclosure will now be described in detail with reference to certain aspects thereof illustrated in the accompanying drawings which are given hereinbelow by way of illustration only, and thus are not limitative of the present disclosure, and wherein:

FIG. 1 is a flowchart illustrating a method for manufacturing a sulfide-based solid electrolyte in accordance with the present disclosure;

FIG. 2 is a triangular diagram of a three-component system, representing the composition of a sulfide-based solid electrolyte in accordance with the present disclosure;

FIG. 3 illustrates a tie-line if the sulfide-based solid electrolyte in accordance with the present disclosure satisfies chemical formula 2, in the triangular diagram of the three-component system of FIG. 2;

FIG. 4 illustrates a tie-line if the sulfide-based solid electrolyte in accordance with the present disclosure satisfies chemical formula 3, in the triangular diagram of the three-component system of FIG. 2;

FIG. 5 is a cross-sectional view of an all solid state battery in accordance with the present disclosure;

FIG. 6 is a graph representing results of test example 1;

FIG. 7 is a graph representing results of test example 2;

FIG. 8 is a graph representing results of test example 3;

FIG. 9 is a graph representing results of test example 4;

FIG. 10 is a graph representing results of test example 5; and

FIG. 11 is a graph representing results of test example 6.

It should be understood that the appended drawings are not necessarily to scale, presenting a somewhat simplified representation of various features illustrative of the basic principles of the disclosure. The specific design features of the present disclosure as disclosed herein, including, for example, specific dimensions, orientations, locations, and shapes, will be determined in part by the particular intended application and use environment.

In the figures, reference numbers refer to the same or equivalent parts of the present disclosure throughout the several figures of the drawing.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

Hereinafter reference will be made in detail to various aspects of the present disclosure, examples of which are illustrated in the accompanying drawings and described below. While the disclosure will be described in conjunction with various aspects, it will be understood that the present description is not intended to limit the disclosure to these aspects. On the contrary, the disclosure is intended to cover not only these aspects, but also various alternatives, modifications, equivalents and other aspects within the spirit and scope of the disclosure as defined by the appended claims.

In the following description of the aspects, terms, such as “including”, “having”, etc., will be interpreted as indicating presence of characteristics, numbers, steps, operations, elements or parts stated in the description or combinations thereof, and do not exclude presence of one or more other characteristics, numbers, steps, operations, elements, parts or combinations thereof, or possibility of adding the same. In addition, it will be understood that, when a part, such as a layer, a film, a region or a plate, is said to be “on” another part, the part may be located “directly on” the other part or other parts may be interposed between both parts. In the same manner, it will be understood that, when a part, such as a layer, a film, a region or a plate, is said to be “under” another part, the part may be located “directly under” the other part or other parts may be interposed between both parts.

All numbers, values and/or expressions representing components, reaction conditions, polymer compositions and amounts of blends used in the description are approximations in which various uncertainties in measurement are reflected and thus, it will be understood that they are modified by a term “about”, unless stated otherwise. In addition, it will be understood that, if a numerical range is disclosed in the description, such a range includes all continuous values from a minimum value to a maximum value, unless stated otherwise. Further, if such a range refers to integers, the range includes all integers from a minimum integer to a maximum integer, unless stated otherwise.

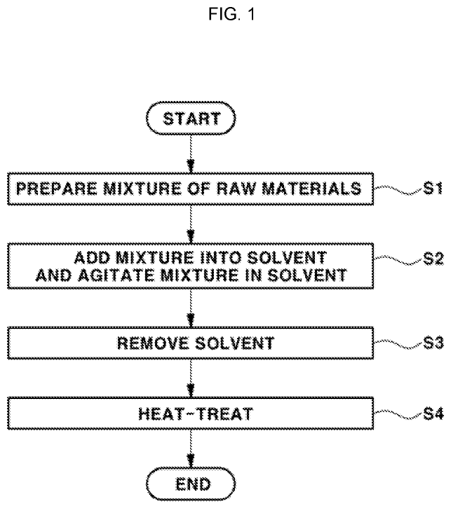

FIG. 1 is a flowchart illustrating a method for manufacturing a sulfide-based solid electrolyte in accordance with the present disclosure. Referring to FIG. 1, the method includes preparing a mixture of raw materials (Operation S1) and adding the mixture into a solvent and agitating the mixture in the solvent (Operation S2).

The method may further include heat-treating an agitated product to manufacture a crystalline sulfide-based solid electrolyte (Operation S4).

The method may further include removing the remaining solvent (Operation S3), prior to heat-treating the agitated product (Operation S4). Removal of the solvent is not limited to a specific method. For example, the solvent may be evaporated in the atmosphere or under specific conditions to be removed.

The present disclosure is technically characterized in that, in manufacture of a five-component, i.e., Li-M-P—S—X, sulfide-based solid electrolyte, a wet process, in which raw materials are reacted in the presence of a solvent, is used differently from conventional methods.

The mixture of the raw materials may include greater than 60 mol % to less than 100 mol % of Li₂S, greater than 0 mol % to less than 40 mol % of P₂S₅ and greater than 0 mol % to 30 mol % or less of MX₄.

M may comprise at least one selected from the group consisting of Ge, Si, Sb, Sn and combinations thereof, particularly Ge or Si.

X may comprise at least one selected from the group consisting of Cl, Br, I and combinations thereof.

The present disclosure is technically characterized in that a novel compound MX₄ is used in addition to lithium sulfide (Li₂S) and diphosphorus pentasulfide (P₂S₅), as the raw materials for the sulfide-based solid electrolyte.

In accordance with the present disclosure, in order to acquire the sulfide-based solid electrolyte having a desired specific composition, contents of the respective raw materials may be properly adjusted in preparing the mixture (Operation 51).

The sulfide-based solid electrolyte may be acquired through reaction caused by adding the prepared mixture to the solvent and agitating the mixture in the solvent (Operation S2).

As the solvent, a solvent which may dissolve or disperse MX₄ may be used. The solvent may comprise at least one selected from the group consisting of tetrahydrofuran (THF), acrylonitrile (AN) and a combination thereof.

A method of adding of the mixture is not limited to a specific method. For example, the mixture may be added to the solvent all at once, or a certain amount of the mixture may be added to the solvent plural times.

In order to cause reaction of the mixture, a composition including the mixture and the solvent is agitated. Agitation is not limited to a specific condition and may be performed at 80 to 1000 RPM for 30 minutes to 48 hours in order to completely terminate the reaction. Further, such agitation may be performed at a temperature of a boiling point of the solvent or lower.

A composition for manufacturing the sulfide-based solid electrolyte in accordance with the present disclosure is used in the wet process, and includes raw materials including Li₂S, P₂S₅ and MX₄, and the solvent.

The sulfide-based solid electrolyte synthesized through the above reaction is an amorphous compound. In order to acquire a crystalline sulfide-based solid electrolyte according to desired purposes, heat treatment of the amorphous sulfide-based solid electrolyte (Operation S4) may be performed.

Here, in the heat treatment (Operation S4), in order to inhibit an undesired reaction, such as a side reaction between the sulfide-based solid electrolyte and the solvent, the remaining solvent after termination of the reaction may be removed (Operation S3).

Such heat treatment may be performed in a vacuum condition, inert gas condition or hydrogen sulfide atmosphere at a temperature of 140 to 800° C. for 30 minutes to 24 hours. Such an inert condition may be created using inert gas, such as argon (Ar), etc.

The crystalline sulfide-based solid electrolyte may be acquired only if the above temperature and time conditions of heat treatment are satisfied. If a heat treatment temperature is lower than the temperature condition or a heat treatment time is shorter than the time condition, a degree of crystallinity may not be sufficient and, if the heat treatment temperature is higher than the temperature condition or the heat treatment time is longer than the time condition, the sulfide-based solid electrolyte may be degraded.

Hereinafter, the sulfide-based solid electrolyte synthesized using the above-described composition through the above-described manufacturing method in accordance with the present disclosure will be described in detail.

The sulfide-based solid electrolyte is expressed as chemical formula 1 below.

A(Li₂S).B(P₂S₅).C(MX₄) [Chemical Formula 1]

Here, A, B and C respectively indicate moles of Li₂S, P₂S₅ and MX₄, and satisfy 60<A<100, 0<B<40, 0<C≤30 and A+B+C=100.

M comprises at least one selected from the group consisting of Ge, Si, Sb, Sn and combinations thereof, particularly Ge or Si.

X comprises at least one selected from the group consisting of Cl, Br, I and combinations thereof.

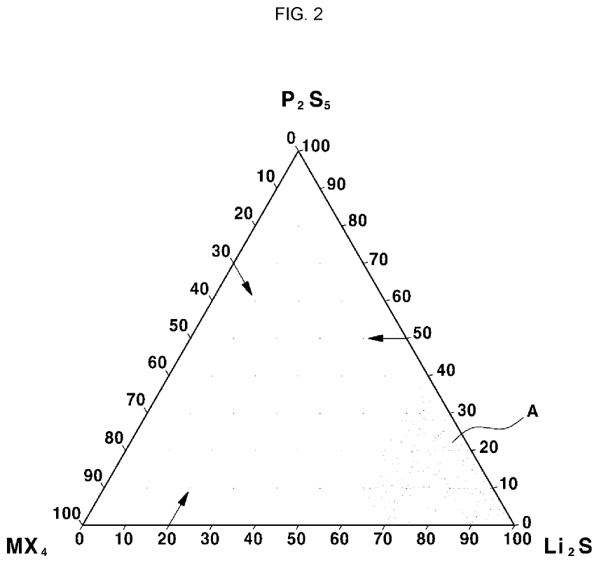

FIG. 2 illustrates an area A occupied by the composition of the sulfide-based solid electrolyte expressed as chemical formula 1, in a triangular diagram of a three-component system of Li₂S, P₂S₅ and MX₄.

The present disclosure is technically characterized in that a sulfide-based solid electrolyte having a novel composition which is not conventionally reported is synthesized using a novel compound MX₄ in addition to lithium sulfide (Li₂S) and diphosphorus pentasulfide (P₂S₅), as raw materials.

The sulfide-based solid electrolyte in accordance with the present disclosure may be expressed as above chemical formula 1 and satisfy a composition of chemical formula 2 below.

(1−x)[y(Li₂S).(100−y)(P₂S₅)].x[(100−z)(Li₂S).z(MX₄)] [Chemical Formula 2]

Here, 0<x≤0.85, 70≤y≤90 and 0<z≤35.

X indicates one element included in MX₄, i.e., X, and is distinguished from x in chemical formula 2 in the description. Those skilled in the art will appreciate distinguishable use of an uppercase “X” and a lowercase “x”.

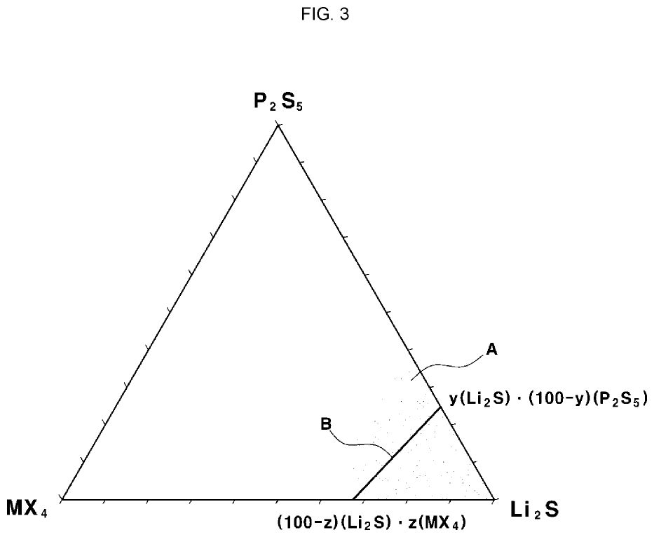

FIG. 3 illustrates a tie-line B of the sulfide-based solid electrolyte satisfying above chemical formula 2, in the triangular diagram of the three-component system. In more detail, the sulfide-based solid electrolyte satisfying chemical formula 2 may belong to the area A and have a composition on the tie-line B.

Referring to FIG. 3, the composition of a compound located at a starting point of the tie-line B may be y(Li₂S).(100−y)(P₂S₅), and the composition of a compound located at an arrival point of the tie-line B according to adding of MX₄ may be (100−z)(Li₂S).z(MX₄).

In above chemical formula 2, y is a factor which determines a molar ratio of Li₂S and P₂S₅ in y(Li₂S).(100−y)(P₂S₅) and the starting point of the tie-line B is varied according to the value of y. The value of y is a number within a range of 70 to 90, and the starting point of the tie-line B moves toward Li₂S as the value of y is increased and moves toward P₂S₅ as the value of y is decreased.

In above chemical formula 2, z is a factor which determines a molar ratio of Li₂S and MX₄ in (100−z)(Li₂S).z(MX₄) and the arrival point of the tie-line B is varied according to the value of z. The value of z is a number within a range of greater than 0 to 35 or less, and the arrival point of the tie-line B moves toward MX₄ as the value of z is increased and moves toward Li₂S as the value of z is decreased.

In above chemical formula 2, a point on the tie-line B at which the composition of the sulfide-based solid electrolyte in accordance with the present disclosure is located is determined according to the value of x. The value of x is a number within a range of greater than 0 to 0.85 or less, and the composition of the sulfide-based solid electrolyte is located on the tie-line B close to the arrival point as the value of x is increased and is located on the tie-line B close to the starting point as the value of x is decreased.

The sulfide-based solid electrolyte in accordance with the present disclosure may be expressed as above chemical formula 1 and satisfy a composition of chemical formula 3 below.

(1−x)(75Li₂S.25P₂S₅).x(67Li₂S.33MX₄) [Chemical Formula 3]

Here, 0<x≤0.85.

X indicates one element included in MX₄, i.e., X, and is distinguished from x in chemical formula 3 in the description. Those skilled in the art will appreciate distinguishable use of an uppercase “X” and a lowercase “x”.

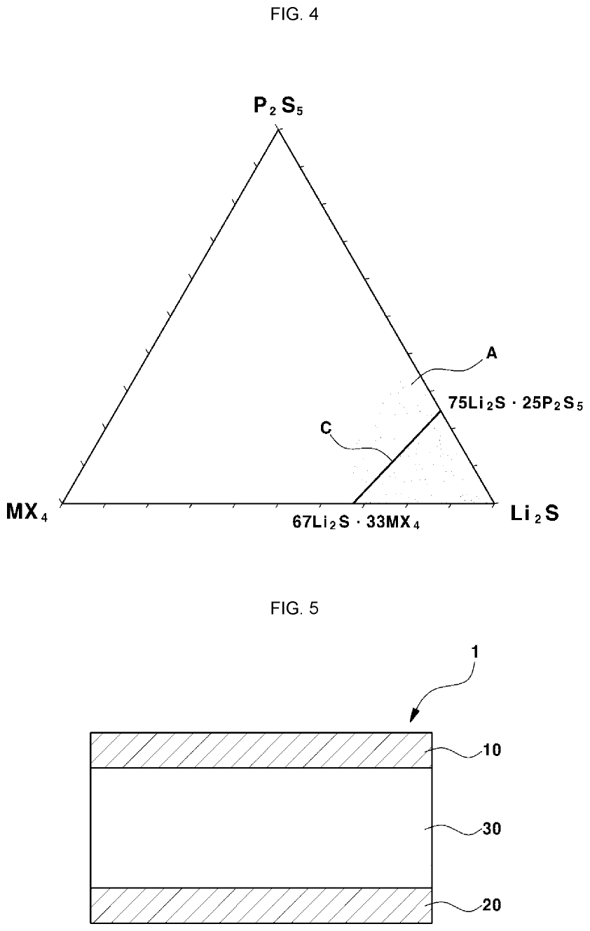

FIG. 4 illustrates a tie-line C of the sulfide-based solid electrolyte satisfying above chemical formula 3, in the triangular diagram of the three-component system. In more detail, the sulfide-based solid electrolyte satisfying chemical formula 3 may belong to the area A and have a composition on the tie-line C.

Referring to FIG. 4, the composition of a compound located at a starting point of the tie-line C may be 75Li₂S.25P₂S₅, and the composition of a compound located at an arrival point of the tie-line C according to adding of MX₄ may be 67Li₂S.33MX₄.

In above chemical formula 3, a point on the tie-line C at which the composition of the sulfide-based solid electrolyte in accordance with the present disclosure is located is determined according to the value of x. The value of x is a number within a range of greater than 0 to 0.85 or less, and the composition of the sulfide-based solid electrolyte is located on the tie-line C close to the arrival point as the value of x is increased and is located on the tie-line C close to the starting point as the value of x is decreased.

FIG. 5 is a cross-sectional view of an all solid state battery in accordance with the present disclosure. Referring to FIG. 5, an all solid state battery 1 includes a positive electrode 10, a negative electrode 20 and a solid electrolyte layer 30 disposed between the positive electrode 10 and the negative electrode 20. At least one of the positive electrode 10, the negative electrode 20 and the solid electrolyte layer 30 includes the sulfide-based solid electrolyte.

The positive electrode 10 may include a positive electrode active material, a conductive material and a solid electrolyte. The positive electrode 10 may further include a binder, as needed.

Although the positive electrode active material is not limited to a specific material, the positive electrode active material may be, for example, an oxide active material or a sulfide active material.

The oxide active material may be a rock salt layer type active material, such as LiCoO₂, LiMnO₂, LiNiO₂, LiVO₂ or Li₁₊ₓNi_{1/3}Co_{1/3}Mn_{1/3}O₂, a spinel type active material, such as LiMn₂O₄ or Li(Ni_{0.5}Mn_{1.5})O₄, an inverse spinel type active material, such as LiNiVO₄ or LiCoVO₄, an olivine type active material, such as LiFePO₄, LiMnPO₄, LiCoPO₄ or LiNiPO₄, a silicon-containing active material, such as Li₂FeSiO₄ or Li₂MnSiO₄, a rock salt layer type active material, a part of transition metal of which is substituted by a different kind of metal, such as LiNi_{0.8}Co_{(0.2-x)}AlₓO₂ (0<x<0.2), a spinel type active material, a part of transition metal of which is substituted by a different kind of metal, such as Li₁₊ₓMn_{2-x-y}M_{y}O₄ (M being at least one selected from the group consisting of Al, Mg, Co, Fe, Ni and Zn, 0<x+y<2), and lithium titanate, such as Li₄Ti₅O₁₂.

The sulfide active material may be copper Chevrel, iron sulfide, cobalt sulfide or nickel sulfide.

The conductive material forms an electron conducting path in the positive electrode 10. The conductive material may be an SP² carbon material, such as carbon black, conductive graphite, ethylene black or carbon nanotubes, or graphene.

The solid electrolyte may be the above-described sulfide-based solid electrolyte. However, the positive electrode 10 may further include a different kind of sulfide-based solid electrolyte in addition to the sulfide-based solid electrolyte in accordance with the present disclosure. The different kind of sulfide-based solid electrolyte may be Li₂S—P₂S₅, Li₂S—P₂S₅—LiI, Li₂S—P₂S₅—LiCl, Li₂S—P₂S₅—LiBr, Li₂S—P₂S₅—Li²O, Li₂S—P₂S₅—Li²O—LiI, Li₂S—SiS², Li₂S—SiS²—LiI, Li₂S—SiS²—LiBr, Li₂S—SiS²—LiCl, Li₂S—SiS²—B₂S₃—LiI, Li₂S—SiS₂—P₂S₅—LiI, Li₂S—B₂S₃, Li₂S—P₂S₅-ZmSn (m and n being positive numbers, Z being one of Ge, Zn and Ga), Li₂S—GeS₂, Li₂S—SiS₂—Li₃PO₄, Li₂S—SiS₂-LiₓMO_{y} (x and y being positive numbers, M being one of P, Si, Ge, B, Al, Ga and In), or Li₁₀GeP₂S₁₂.

The negative electrode 20 may be a composite including an negative electrode active material, a conductive material and a solid electrolyte. The composite may further include a binder, as needed. However, the negative electrode 20 may be a lithium metal or a lithium foil.

Although the negative electrode active material is not limited to a specific material, the negative electrode active material may be, for example, a carbon active material or a metal active material.

The carbon active material may be mesocarbon microbeads (MCMBs), graphite, such as highly-oriented pyrolytic graphite (HOPG), or amorphous carbon, such as hard carbon or soft carbon.

The metal active material may be one selected from the group consisting of In, Al, Si, Sn and alloys including at least one thereof.

The conductive material of the negative electrode 20 may be the same as or different from the conductive material of the positive electrode 10. For example, the conductive material of the negative electrode 20 may be an SP² carbon material, such as carbon black, conductive graphite, ethylene black or carbon nanotubes, or graphene.

The solid electrolyte may be the above-described sulfide-based solid electrolyte. However, the negative electrode 20 may further include a different kind of sulfide-based solid electrolyte in addition to the sulfide-based solid electrolyte in accordance with the present disclosure. The different kind of sulfide-based solid electrolyte of the negative electrode 20 may be the same as that of the positive electrode 10.

The solid electrolyte layer 30 includes the sulfide-based solid electrolyte in accordance with the present disclosure. The solid electrolyte layer 30 may further include a binder, as needed.

The present disclosure provides a sulfide-based solid electrolyte having a novel composition synthesized through a wet process using a new raw material, as described above, and the present disclosure will be described in more detail through the following examples. The following examples are only for enhancement of understanding of the disclosure and are not intended to limit the scope of the disclosure.

### EXAMPLES AND COMPARATIVE EXAMPLES

A mixture including raw materials having contents stated in Table 1 below was prepared. Among the raw materials, Gel₄ was used as MX₄.

The mixture was added to tetrahydrofuran (THF) serving as a solvent and then agitated. The mixture in the solvent was continuously agitated overnight so that reaction was completely terminated.

After termination of the reaction, the remaining solvent was removed.

A product acquired by removing the solvent was heat-treated under conditions stated in Table 1 and, thereby, sulfide-based solid electrolytes according to examples 1 to 8 and comparative example were acquired.

TABLE 1

| | Contents of raw | | | | | |
|---|---|---|---|---|---|---|
| | materials [mol %] | | | Heat-treatment conditions | | |
| Division | Li₂S(A) | P₂S₅(B) | Gel₄(C) | Temp.[° C.] | Atmosphere | Time[hr] |
| Example 1 | 73.79 | 21.21 | 5 | 140 | Ar | 1 |
| Example 2 | 72.58 | 17.42 | 10 | 140 | Ar | 1 |
| Example 3 | 71.36 | 13.64 | 15 | 140 | Ar | 1 |
| Example 4 | 70.15 | 9.85 | 20 | 140 | Ar | 1 |
| Example 5 | 67.73 | 2.27 | 30 | 140 | Ar | 1 |
| Example 6 | 72.58 | 17.42 | 10 | 200 | Ar | 1 |
| Example 7 | 72.58 | 17.42 | 10 | 240 | Ar | 1 |
| Example 8 | 72.58 | 17.42 | 10 | 240 | Vacuum | 1 |
| Comparative example | 75 | 25 | 0 | 140 | Ar | 1 |

### Test Example 1—Measurement of Ionic Conductivity and Activation Energy According Change in Amount of C

Ionic conductivities (σ₃₀) and activation energies (Eₐ) of the sulfide-based solid electrolytes according to examples 1 to 5 and comparative example were measured.

The ionic conductivities (σ₃₀) were measured as follows. Samples having a diameter of 6 mm and a weight of 30 mg were manufactured by charging a mold for measuring conductivity with respective powders and then performing uniaxial cold compression molding at 370 MPa. Impedances of the samples were acquired by applying AC potential of 50 mA to the samples and then performing frequency sweep from 1 Hz to 3 MHz.

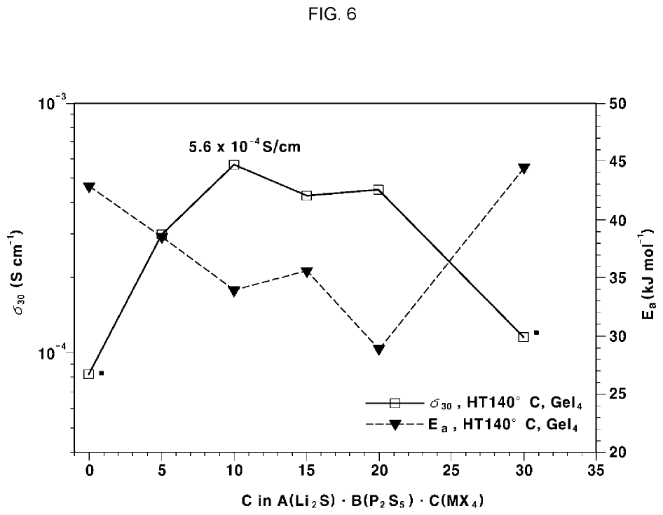

The activation energies (Eₐ) were measured as follows. The ionic conductivities (σ₃₀) of the samples according to temperatures were measured and the activation energies (Eₐ) were calculated through the Arrhenius equation. FIG. 6 and Table 2 represent the measured ionic conductivities (σ₃₀) and activation energies (Eₐ).

TABLE 2

| Division | Ionic conductivity[S/cm] | Activation energy[kJ/mol] |
|---|---|---|
| Example 1 | 1.2 × 10⁻⁴ | 38.4 |
| Example 2 | 4.5 × 10⁻⁴ | 33.9 |
| Example 3 | 4.3 × 10⁻⁴ | 35.5 |
| Example 4 | 5.6 × 10⁻⁴ | 28.8 |
| Example 5 | 3.0 × 10⁻⁴ | 44.4 |
| Comparative | 8.2 × 10⁻⁵ | 42.9 |
| example | | |

Referring to FIG. 6 and Table 2, it may be confirmed that the ionic conductivity of the sample of example 1 is greatly improved, as compared to that of the sample of comparative example. Further, the sample of example 2 including a higher C (Gelₐ) content than the sample of example 1 exhibits a greater ionic conductivity, and the sample of example 5 including 30 mol % of C exhibits somewhat lower ionic conductivity than the samples of other examples. However, the ionic conductivity of the sample of example 5 is also higher than that of the sample of comparative example.

Further, the activation energies of the samples of examples 1 to 4 are lower than that of the sample of comparative example. This means that the samples of examples 1 to 4 exhibit faster Li ion diffusion than the sample of comparative example and may thus implement an all solid state battery having excellent output.

### Test Example 2—Xrd Pattern Analysis According to Change in Amount of C

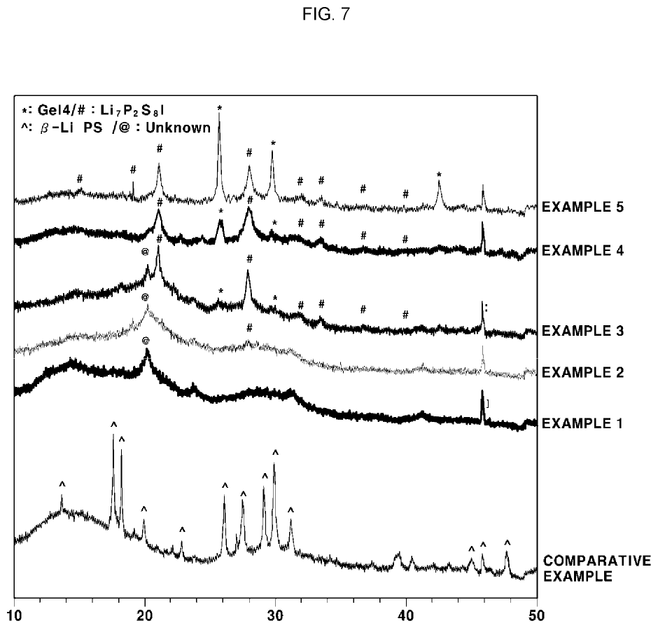

X-ray diffusion (XRD) analysis of the sulfide-based solid electrolytes according to examples 1 to 5 and comparative example was performed. The respective samples were placed on an exclusive XRD holder which is closed, and regions of the samples, satisfying 10°≤2θ≤60°, were measured in a condition of scan speed of 1.2°/min. FIG. 7 illustrates results of measurement.

Referring to FIG. 7, it may be confirmed that XRD patterns of the samples of examples 1 to 5 and comparative example are completely different. Values of 2θ representing peaks were 17.5°±0.5°, 18.1°±0.5°, 20.0°±0.5°, 20.9°±0.5°, 25.0°±0.5°, 27.8°±0.5°, 29.2°±0.5°, 30.0°±0.5°, 31.4°±0.5° and 33.3°±0.5°.

For reference, the samples of examples 1 and 2 do not clearly represent the peaks represented by the samples of examples 3 to 5 and it is assumed that the reason for this is that crystalline structures are not sufficiently grown to be measured by a measurement device due to relatively low heat-treatment temperatures. Since the samples of examples 6 to 8 which have the same composition as the sample of example 2 but were heat-treated at higher temperatures show all of the peaks represented by the samples of examples 3 to 5, such an assumption is possible.

However, although the above-described XRD pattern is not detected from the samples of examples 1 and 2, it may not be concluded that the samples of examples 1 and 2 are sufficiently crystallized. The reason for this is that the samples of examples 1 and 2 have considerably high ionic conductivities and these ionic conductivities belong to a level which may be achieved by a crystalline sulfide-based solid electrolyte.

### Test Example 3—Measurement of Ionic Conductivity and Activation Energy According to Change of Heat-Treatment Temperature

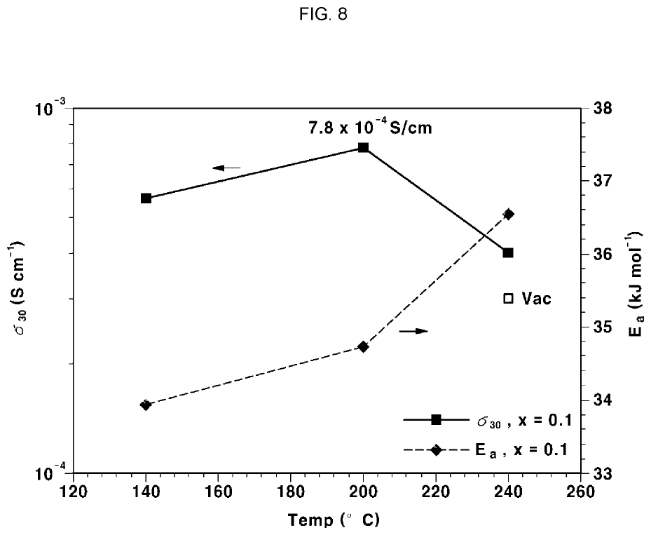

Ionic conductivities (σ₃₀) and activation energies (Eₐ) of the sulfide-based solid electrolytes according to examples 2, 6 and 7 were measured. A measurement method is the same as the measurement method of test example 1. FIG. 8 illustrates results of measurement.

Referring to FIG. 8, it may be confirmed that the sample of example 6 which was heat-treated at a temperature of 200° C. exhibits the highest ionic conductivity (σ₃₀). The ionic conductivity (σ₃₀) of the sample of example 6 is about 9.5 times as high as the ionic conductivity (σ₃₀) of the sample of comparative example. Further, all the activation energies (Eₐ) of the samples of examples 2, 6 and 7 are lower than the activation energy (Eₐ) of the sample of comparative example.

### Test Example 4—Xrd Pattern Analysis According to Change of Heat-Treatment Temperature

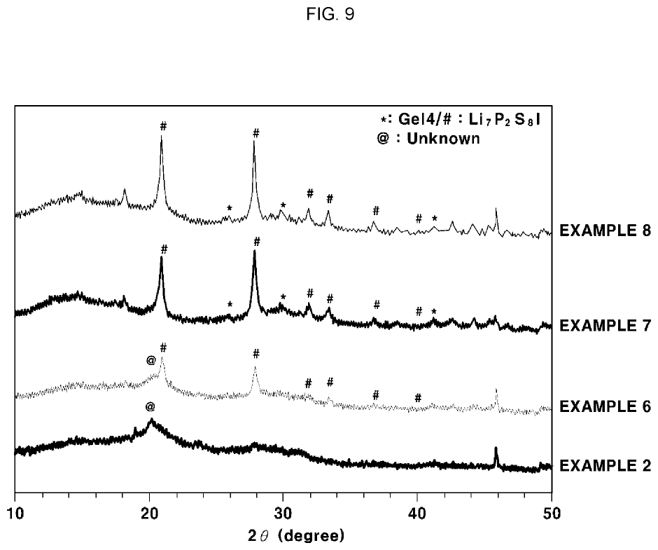

X-ray diffusion (XRD) analysis of the sulfide-based solid electrolytes according to examples 2 and 6 to 8 was performed. An analysis method is the same as the analysis method of test example 2. FIG. 9 illustrates results of analysis.

Referring to FIG. 9, it may be confirmed that the samples of examples 6 to 8 more clearly represent peaks corresponding to Li₇P₂S₈I.

### Test Example 5—Raman Analysis

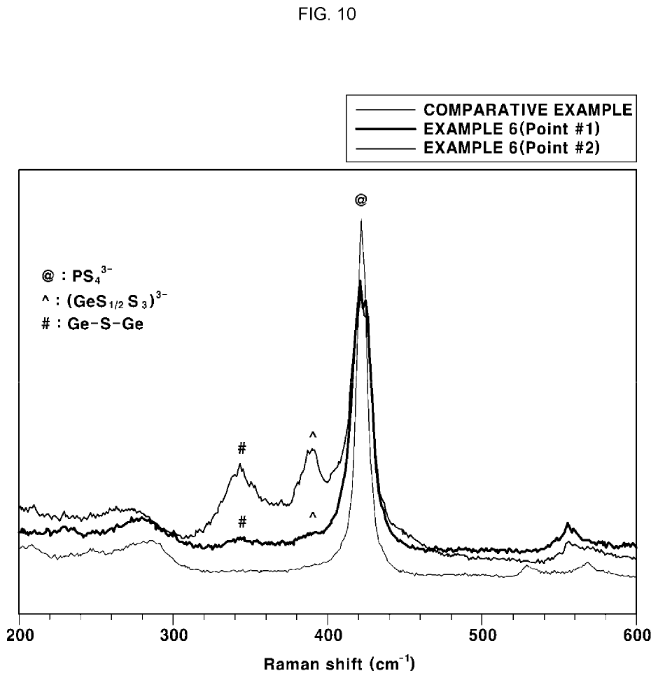

Raman analysis of the sulfide-based solid electrolyte of example 6 having the highest ionic conductivity and the sulfide-based solid electrolyte of comparative example was performed. The respective samples were placed on a closed holder, and molecular vibration spectra of the samples were measured for 60 seconds by emitting an argon-ion laser of a wavelength of 532 nm thereto. FIG. 10 illustrates results of analysis.

Referring to FIG. 10, it may be confirmed that the sample of example 6 has negative ion cluster distributions of PS₄³⁻ and (MS_{1/2}S₃)³⁻ and has M-S bonding of Ge—S—Ge. On the other hand, the sample of comparative example has a negative ion cluster distribution of PS₄³⁻ alone and does not exhibit M-S bonding.

### Test Example 6—Evaluation of Cell Performance

All solid state batteries using the sulfide-based solid electrolytes according to example 6 and comparative example were manufactured, and cell performances of the all solid state batteries were evaluated.

150 mg of each of the sulfide-based solid electrolytes according to example 6 and comparative example was added to a mold, and then low pressure of about 74 MPa was applied thereto, thus manufacturing solid electrolyte layers.

A positive electrode was uniformly applied to one surface of the solid electrolyte layer. The positive electrode having a composition including 68% by weight of nickel cobalt manganese oxide (NCM 711) serving as a positive electrode active material, 29.1% by weight of the sulfide-based solid electrolyte and 2.9% by weight of a conductive material (Super C 65) was used. 15 mg of the positive electrode was applied to the solid electrolyte layer.

A Li—In negative electrode was loaded on the other surface of the solid electrolyte layer.

A high pressure of about 370 MPa was applied to a stack of the positive electrode, the solid electrolyte layer and the negative electrode, thus completing manufacture of the all solid state battery.

After thermal equilibrium, charging and discharging of the all solid state battery was performed. Such charging and discharging of the all solid state battery was performed at a voltage cut-off of 3.0-4.3 V, a C-rate of 0.1 C and a temperature of 30° C.

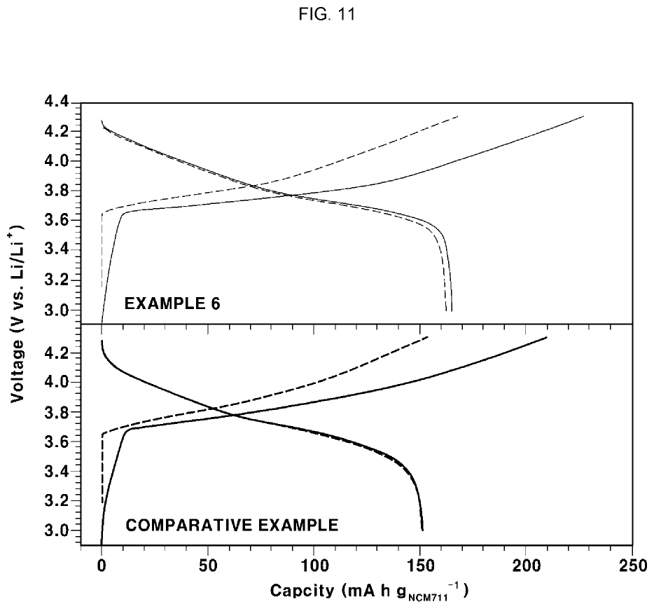

FIG. 11 illustrates results of evaluation. Referring to FIG. 11, it may be confirmed that the all solid state battery manufactured using the sulfide-based solid electrolyte according to example 6 has a greater capacity than the all solid state battery manufactured using the sulfide-based solid electrolyte according to comparative example.

The sulfide-based solid electrolyte and the all solid state battery including the same in accordance with the present disclosure may be used in all electrochemical cells using a solid electrolyte. Particularly, the sulfide-based solid electrolyte and the all solid state battery including the same in accordance with the present disclosure may be applied to various fields and products, such as an energy storage system using a secondary battery, a battery for electric vehicles or hybrid electric vehicles, a portable power supply system of an unmanned robot or Internet of Things, etc.

As is apparent from the above description, the present disclosure provides a novel sulfide-based solid electrolyte having a new composition and high ionic conductivity.

Further, the present disclosure provides a method for manufacturing a sulfide-based solid electrolyte suitable for large scale and mass production.

The disclosure has been described in detail with reference to aspects thereof. However, it will be appreciated by those skilled in the art that changes may be made in these aspects without departing from the principles and spirit of the disclosure, the scope of which is defined in the appended claims and their equivalents.

What is claimed is:

1. A sulfide-based solid electrolyte expressed as chemical formulal,
A(Li₂S).B(P₂S₅).C(MX₄) [Chemical Formula 1]
wherein:
A, B and C are respectively moles of Li₂S, P₂S₅ and MX₄, and satisfy 60<A<100, 0<B<40, 0<C≤30 and A+B+C=100;
M comprises at least one selected from the group consisting of Ge, Si, Sb, Sn, and combinations thereof; and
X comprises at least one selected from the group consisting of Cl, Br, I and combinations thereof.

2. The sulfide-based solid electrolyte of claim 1, satisfying a composition expressed as chemical formula 2,
(1−x)[y(Li₂S).(100−y)(P₂S₅)].x[(100−z)(Li₂S).z(MX₄)], [Chemical Formula 2]
wherein 0<x≤0.85, 70≤y≤90 and 0<z≤35.

3. The sulfide-based solid electrolyte of claim 2, satisfying a composition expressed as chemical formula 3,
(1−x)(75Li₂S.25P₂S₅).x(67Li₂S.33MX₄) [Chemical Formula 3]
wherein 0<x≤0.85.

4. The sulfide-based solid electrolyte of claim 1, representing peaks in ranges of 2θ=17.5°±0.5°, 18.1°±0.5°, 20.0°±0.5°, 20.9°±0.5°, 25.0°±0.5°, 27.8°±0.5°, 29.2°±0.5°, 30.0°±0.5°, 31.4°±0.5° and 33.3°±0.5° when an X-ray diffusion (XRD) pattern is measured.

5. The sulfide-based solid electrolyte of claim 1, having negative ion cluster distributions of PS₄³⁻ and (MS_{1/2}S₃)³⁻ and having M-S bonding.

6. A composition for manufacturing the sulfide-based solid electrolyte of claim 1, the composition comprising:
raw materials comprising Li₂S, P₂S₅ and MX₄; and
a solvent configured to dissolve or disperse the MX₄.

7. The composition of claim 6, wherein the raw materials comprise:
greater than 60 mol % to less than 100 mol % of Li₂S;
greater than 0 mol % to less than 40 mol % of P₂S₅; and
greater than 0 mol % to 30 mol % or less of the MX₄.

8. The composition of claim 6, wherein the solvent comprises at least one selected from the group consisting of tetrahydrofuran (THF), acrylonitrile (AN) and a combination thereof.

9. A method for manufacturing the sulfide-based solid electrolyte of claim 1, comprising:
preparing a mixture of raw materials; and
adding the mixture into a solvent and agitating the mixture in the solvent.

10. The method of claim 9, further comprising heat-treating an agitated product.

11. The method of claim 9, wherein the raw materials comprise:
greater than 60 mol % to less than 100 mol % of Li₂S;
greater than 0 mol % to less than 40 mol % of P₂S₅; and
greater than 0 mol % to 30 mol % or less of the MX₄.

12. The method of claim 9, wherein the solvent comprises at least one selected from the group consisting of tetrahydrofuran (THF), acrylonitrile (AN) and a combination thereof.

13. The method of claim 10, further comprising removing the solvent, prior to the heat-treating the agitated product.

14. The method of claim 10, wherein the heat-treating is performed in a vacuum condition, inert gas condition or hydrogen sulfide atmosphere at a temperature of 140 to 800° C. for 30 minutes to 12 hours.

15. An all solid state battery comprising:
a positive electrode;
a negative electrode; and
a solid electrolyte layer disposed between the positive electrode and the negative electrode,
wherein at least one of the positive electrode, the negative electrode and the solid electrolyte layer comprises the sulfide-based solid electrolyte of claim 1.

16. A vehicle comprising the all solid state battery of claim 15.
